(19) United States
(12) Patent Application Publication
(10) Pub. No.: US 2012/0254032 A1
(43) Pub. Date: Oct. 4, 2012

(54) MOBILE WIRELESS COMMUNICATIONS DEVICE CONFIGURED TO AUTHORIZE TRANSACTION BASED UPON MOVEMENT SENSOR AND ASSOCIATED METHODS

(75) Inventors: SANTIAGO CARBONELL DUQUE, Bogota (CO); J. David Hagedorn, Waterloo (CA)

(73) Assignee: Research In Motion Limited, Waterloo (CA)

(21) Appl. No.: 13/074,471

(22) Filed: Mar. 29, 2011

(51) Int. Cl. G06Q 40/00

(52) U.S. Cl. 705/44

(57) ABSTRACT

A transaction processing system includes an authorization server and an authorization server. A transaction terminal includes a first near field communication (NFC) device and is configured to perform a transaction based upon the authorization data. A mobile wireless communications device includes a second NFC device, at least one movement sensor, and a processor. The processor is configured to send a transaction request via the second NFC device to the first NFC device of the transaction terminal, and send detected data representing a pattern of movement detected by the at least one movement sensor to the authorization server. The authorization server is configured to generate authorization data based upon the detected data. The transaction terminal is configured to perform the transaction based upon the transaction request and the authorization data.

### TECHNICAL FIELD

The present disclosure relates to communications systems, and, more particularly, to mobile wireless communications systems and related methods.

### BACKGROUND

Mobile communication systems continue to grow in popularity and have become an integral part of both personal and business communications. Various mobile devices now incorporate Personal Digital Assistant (PDA) features such as calendars, address books, task lists, calculators, memo and writing programs, media players, games, etc. These multi-function devices usually allow electronic mail (email) messages to be sent and received wirelessly, as well as access the internet via a cellular network and/or a wireless local area network (WLAN), for example.

Some mobile devices incorporate contactless card technology and/or near field communication (NFC) chips. NFC technology is commonly used for contactless short-range communications based on radio frequency identification (RFID) standards, using magnetic field induction to enable communication between electronic devices, including mobile wireless communications devices. This short-range high frequency wireless communications technology exchanges data between devices over a short distance, such as only a few centimeters.

### BRIEF DESCRIPTION OF THE DRAWINGS

FIG. 1 is a schematic block diagram of a transaction processing system in accordance with an example embodiment.

FIG. 2 is a schematic block diagram of a transaction processing system in accordance with an alternative example embodiment.

FIG. 3 is a schematic block diagram of a transaction processing system in accordance with a further example embodiment.

FIG. 4 a schematic block diagram of a transaction processing system in accordance with an additional example embodiment.

FIG. 5 is a flowchart of a method of operating the transaction processing system of FIG. 2.

FIG. 6 is a flowchart of a method of operating the transaction processing system of FIG. 3.

FIG. 7A shows the mobile wireless communications device of FIG. 1 at the start of being moved in a pattern of movement, at a first time.

FIG. 7B shows the mobile wireless communications device of FIG. 1 being moved in a pattern of movement, at a second time.

FIG. 7C shows the mobile wireless communications device of FIG. 1 at the end of being moved in a pattern of movement, at a third time.

FIG. 8 is a schematic block diagram illustrating example components of a mobile wireless communications device that may be used with the transaction processing systems of FIGS. 1, 2, 3, and 4.

### DETAILED DESCRIPTION

The present description is made with reference to the accompanying drawings, in which various example embodiments are shown. However, many different embodiments may be used, and thus the description should not be construed as limited to the embodiments set forth herein. Rather, these embodiments are provided so that this disclosure will be thorough and complete. Like numbers refer to like elements throughout, and prime notation and multiple prime notation are used to indicate similar elements or steps in alternative embodiments.

Generally speaking, a transaction processing system is provided herein which may include an authorization server and a transaction terminal. The transaction terminal may include a first near field communication (NFC) device. The system may further include a mobile wireless communications device, which may include a second NFC device, at least one movement sensor, and a processor configured to send a transaction request to the first NFC device of the transaction terminal, and to send detected gesture data representing a pattern of movement detected by the at least one movement sensor to the authorization server. The authorization server may be configured to generate authorization data based upon the detected gesture data, and the transaction terminal may be configured to perform a transaction based upon the transaction request and the authorization data. This transaction processing system advantageously allows for quick, easy, and secure authorization of transactions.

In addition, the authorization server may also be configured to send the authorization data to the mobile wireless communications device, and the processor may also be configured to send the authorization data to the transaction terminal via communication between the first and second NFC devices.

Also, the mobile wireless communications device may further comprise a wireless transceiver, and the processor may be configured to send the detected gesture data to the authorization server via the wireless transceiver. The processor may be configured to send the detected gesture data to the authorization server via the transaction terminal.

Moreover, the mobile wireless communications device may include an input device, and the processor may generate the detected gesture data based upon the pattern of movement detected by the at least one movement sensor and the input device.

In some applications, the authorization server may further comprise a memory configured to store gesture data. The authorization server may then be configured to generate the authorization data by comparing the detected gesture data to the stored gesture data. In accordance with one example, the transaction may comprise causing a transfer of funds from a payment account associated with the authorization data to a merchant account. In another example, the transaction may comprise a security transaction. The at least one movement sensor may include at least one of an accelerometer, a magnetometer, or a gyroscope, for example.

A method aspect is directed to a method of operating transaction processing system comprising an authorization server, a mobile wireless communications device, and a transaction terminal. The method may comprise sending detected gesture data representing a pattern of movement detected by at least one movement sensor of the mobile wireless communications device to the authorization server using a processor of the mobile wireless communications device. The method may also include generating authorization data based upon the detected gesture data, using a processor of the authorization server, and engaging wireless communications between the mobile wireless communications device and the transaction terminal via cooperation between a first NFC device of the transaction terminal and a second NFC device of the mobile wireless communications device. The method may further include performing a transaction based upon the authorization data, using the transaction terminal.

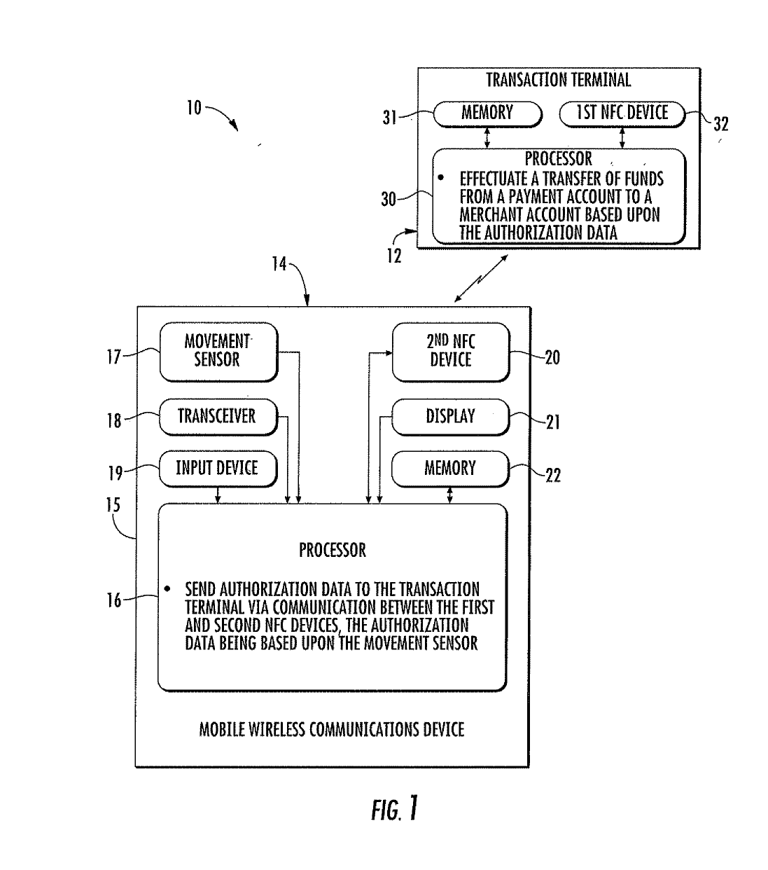

Referring initially to FIG. 1, a transaction processing system 10 is now described. The transaction processing system 10 illustratively includes a transaction terminal 12, such as a point-of-sale (POS) terminal, for example. The transaction terminal 12 includes a processor 30 coupled to a memory 31 and a first NFC device 32. The processor 30 is configured to effectuate a transfer of funds from a payment account, such as a bank account (e.g., checking account, savings account, debit card, etc.) or a credit card or a gift card, to a merchant account, based upon received authorization data.

The transaction processing system 10 also illustratively includes a mobile wireless communications device 14. Example mobile wireless communications devices 14 may include portable or personal media players (e.g., music or MP3 players, video players, etc.), remote controls (e.g., television or stereo remotes, etc.), portable gaming devices, portable or mobile telephones, smartphones, tablet computers, etc. In this embodiment, the mobile wireless communications device 14 is capable of sending authorization data, such as transaction authorization data, to the transaction terminal 12.

The mobile wireless communications device 14 includes a processor 16 coupled to a movement sensor 17, transceiver 18, an input device 19, a second NFC device 20, a display 21, and a memory 22. The mobile wireless communications device 14 includes a housing 15 carrying the processor 16, the movement sensor 17, the transceiver 18, the input device 19, the second NFC device 20, the display 21, and the memory 22.

Generally speaking, the movement sensor 17 may comprise a sensor or combination of sensors that are capable of determining movement of the mobile wireless communications device 14. For example, the movement sensor 17 may comprise an accelerometer, a magnetometer, or a gyroscope. In some applications, the movement sensor 17 may be a camera or an image sensor.

The input device 19 may comprise a keyboard, a touch sensitive pad, a trackball, a thumbwheel, a button, a microphone, or other suitable device, for example. It should be appreciated that in some applications, the display 21 may comprise a touch sensitive display, and may therefore serve as the input device 19. In addition, the transceiver 18 may comprise a cellular transceiver, and may be configured to perform both voice and data cellular communications. The memory 22 may include volatile and non-volatile portions. Other wireless formats may also be used, such as Bluetooth, wireless local area networks (WLANs), and WiMAX, for example.

By way of background, NFC is a short-range wireless communications technology in which NFC-enabled devices are “swiped,” “bumped” or otherwise moved in close proximity to communicate. In one non-limiting example implementation, NFC may operate at 13.56 MHz and with an effective range of about 10 cm, but other suitable versions of near-field communication which may have different operating frequencies, effective ranges, etc., for example, may also be used.

The processor 16 is configured to send authorization data to the transaction terminal 12 via communication between the first NFC device 32 and second NFC device 20. The authorization data is based upon the movement sensor 17, as will be described in further detail below.

The authorization data may be data that indicates an authorization for funds to be transferred from the payment account to the merchant account, and not merely data indicating an account number or identifier of the payment account. Alternatively, the authorization data may be the account number or account access information. It should also be noted that in some embodiments the authorization data may be transaction terminal 12 and then authenticated, an in other embodiments the authentication may be performed by the mobile wireless communications device 14 and payment details sent to the transaction terminal as the authorization data. For example, a particular credit card account may be accessible over NFC based upon a gesture, and the transaction terminal 12 (e.g., a payment terminal) “sees” the credit card information just as if the user had physically swiped the credit card, as will be discussed further below.

The movement sensor 17 may detect an orientation of the mobile wireless communications device 14, as well as changes to the orientation. The movement sensor 17 may also determine the direction in which the mobile wireless communications device 14 is pointing (e.g., north, south, east, west, etc.). Further, the movement sensor 17 may determine acceleration of the mobile wireless communications device 14 in a given direction.

The movement sensor 17 may detect movement of the mobile wireless communications device 14 in a pattern of movement representing a “gesture”, and the authorization data may accordingly be based upon such a gesture. As a brief example, an example gesture may comprise holding the mobile wireless communications device 14 such that it is perpendicular with the ground, rotating it such that it is parallel to the ground, and then shaking it twice. Generally speaking, a gesture may comprise a movement, sequence, or pattern of movements of the mobile wireless communications device 14.

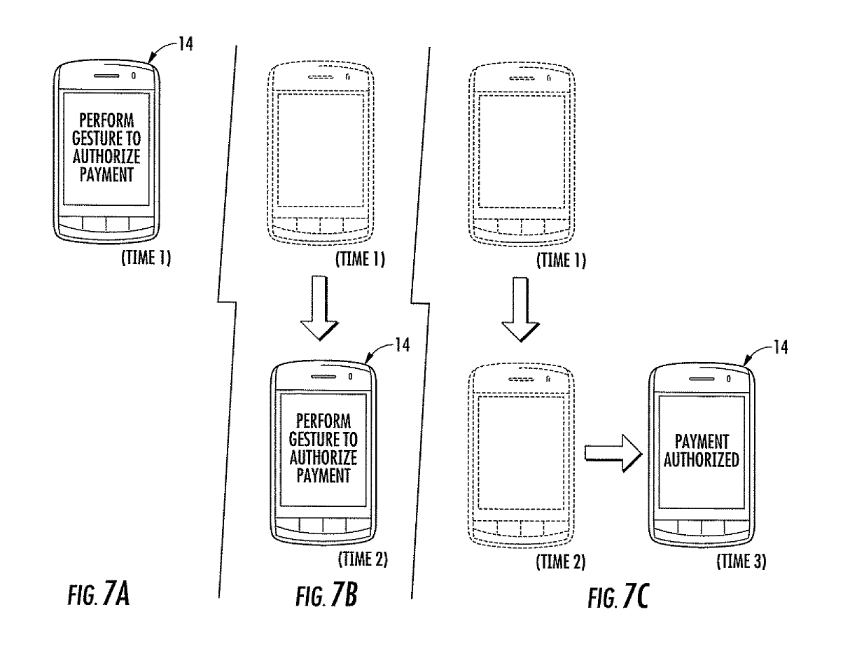

An example gesture is shown in FIGS. 7A-7C. Here, the mobile wireless communications device 14 presents a prompt stating “Perform Gesture To Authorize Payment” on the display 21, and is held at a first location during a first time (Time 1), as seen in FIG. 7A. The mobile wireless communications device 14 is then moved downward from the first location to a second location at a second time (Time 2), as shown in FIG. 7B. Thereafter, the mobile wireless communications device 14 is moved to the right from the second location to a third location at a third time (Time 3), as seen in FIG. 7C. This completes the gesture, and the display 21 displays a “Payment Authorized” message.

The gesture may also include orienting the mobile wireless communications device 14 in a given direction. For example, one gesture may be to orient the mobile wireless communications device 14 such that it is facing north, then shake the mobile wireless communications device three times. In such a case wherein the gesture includes orientation of the mobile wireless communications device 14 in a direction, the processor 16 may display a compass on the display 21, allowing an individual to more easily orient the mobile wireless communications device in the desired direction.

In some examples, a gesture may also include input received via the input device 19. For example, a gesture may include moving the mobile wireless communications device 14 in a first direction, pressing a button of the input device 19, then moving the mobile wireless communications device in a second direction. If the input device 19 comprises a microphone, the gesture may include moving the mobile wireless communications device 14 in a first direction, speaking a word or phrase, then moving the mobile wireless communications device in a second direction, for example.

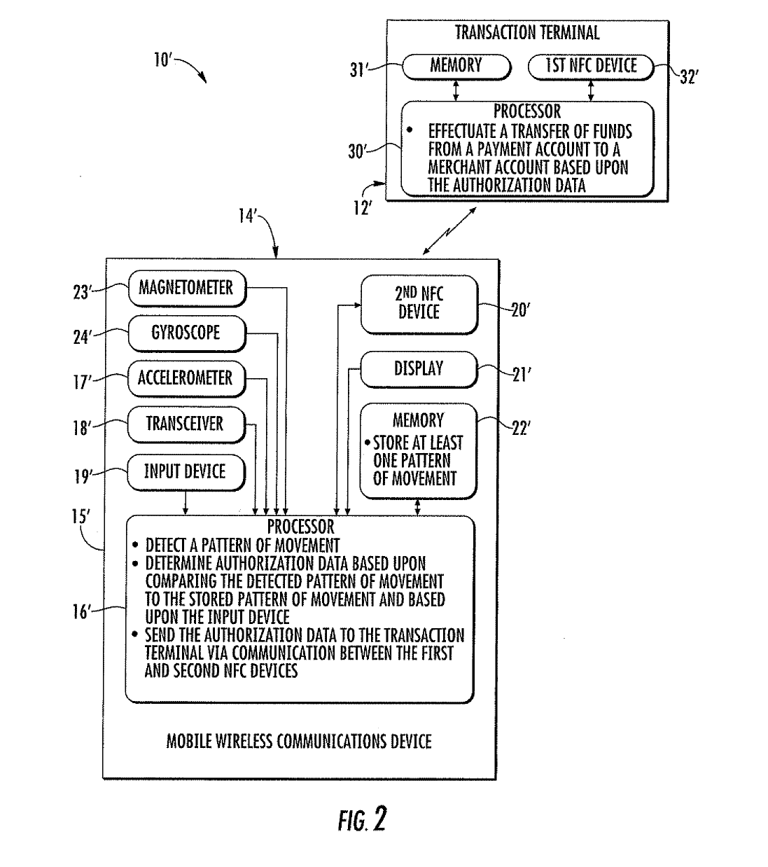

In some example embodiments, the processor 16 may detect the pattern of movement, determine the authorization data based upon the pattern of movement, and send authorization data to the transaction terminal 12. One such example embodiment is now described with reference to FIG. 2. Here, the mobile wireless communications device 14′ includes an accelerometer 17′, a magnetometer 23′, and a gyroscope 24′, although it should be understood that various combinations of these or other motion sensors may be used in different embodiments. The accelerometer 17′ is configured to detect acceleration of the mobile wireless communications device 14′, and is therefore also capable of determining a change in the orientation of the mobile wireless communications device. In addition, the magnetometer 23′ is configured to determine the direction in which the mobile wireless communications device 14′ is pointing (e.g., north, south, east, west, etc.). Further, the gyroscope 24′ is configured to detect an orientation of the mobile wireless communications device 14′, as well as changes to the orientation. That is, the gyroscope 24′ may detect when the mobile wireless communications device 14′ is turned, twisted, or pointed in a given direction.

The memory 22′ stores at least one pattern of movement representing a gesture. This pattern of movement may include motion of the mobile wireless communications device 14′ in any direction, as well as turning, twisting, and shaking of the mobile wireless communications device, together with input received via the input device 19′. The stored pattern of movement may also include orientations of the mobile wireless communications device 14′ in one or more directions, for example.

The stored pattern of movement may be stored in the memory 22′ during an association setting mode. In this mode, a gesture is performed, saved in the memory 22′, and then associated with a given payment account via the input device 19′. Default patterns of movement may also be stored, such as at a time of manufacture or initialization of the mobile wireless communications device 14′, for example.

The processor 16′ detects a pattern of movement via at least one of the accelerometer 17′, the magnetometer 23′, or the gyroscope 24′, for example. The processor 16′ then compares the detected pattern of movement to the stored pattern of movement, and determines the authorization data based upon that comparison. Therefore, if the detected pattern of movement sufficiently matches or substantially corresponds with the stored pattern of movement, the authorization data will be generated. If the detected pattern of movement does not sufficiently match or substantially correspond with the stored pattern of movement, the authorization data will not be generated. The processor 16′ then sends the authorization data to the transaction terminal 12′ via communications between the first NFC device 32′ and the second NFC device 20′, and the transaction terminal 12′ may then effectuate the transfer of funds from the payment account to the merchant account based upon the authorization data.

Due to the minute, yet detectable, differences in the way any given individual will perform a given gesture, authorization of a transfer of funds based upon a detected gesture or pattern of movement may be particularly secure. For example, different individuals may hold the mobile wireless communications device 14′ in a different position in their hands, and such an orientation may be detected via the gyroscope 24′. Different individuals may move the mobile wireless communications device 14′ more quickly or more slowly, or may change the direction in which the mobile wireless communications device is moving more forcefully or less forcefully, which may be detected via the accelerometer 17′.

Therefore, even an unauthorized user of the mobile wireless communications device 14′ who is generally aware of the proper gesture to perform to authorize a transaction may not be able to perform the gesture in such a way that the detected pattern of movement matches the stored pattern of movement (e.g., the unauthorized user may perform the gesture too quickly or slowly, may change directions while performing the gesture too forcefully or not forcefully enough, or may hold the mobile wireless communications device at an improper angle). This transaction processing system 10′ therefore enhances the security of transactions over conventional transaction processing systems.

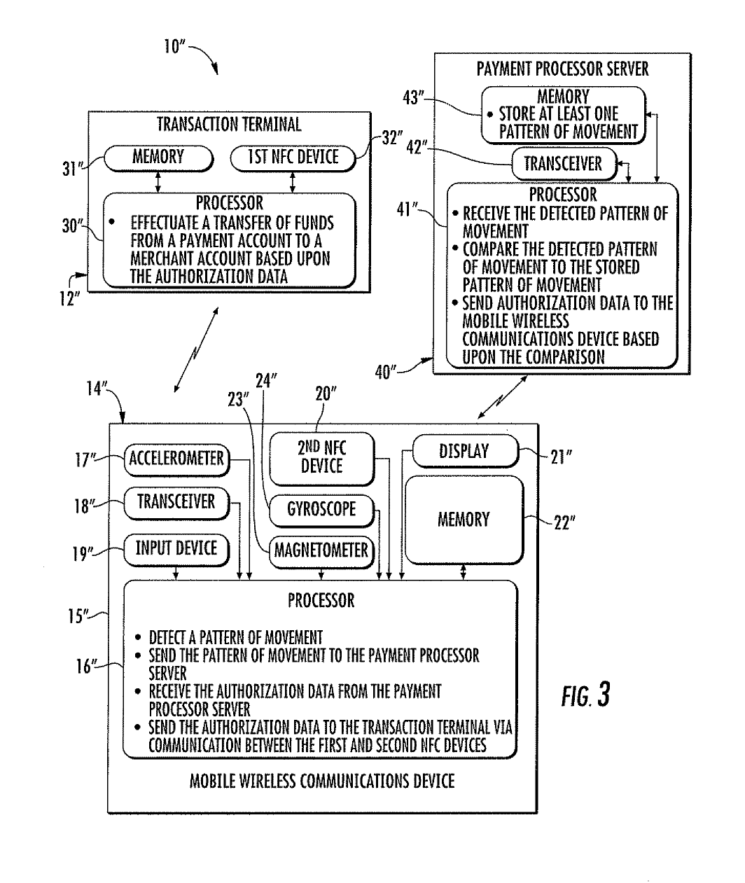

In other embodiments, the processor 16 may be configured to detect the pattern of movement, send detected gesture data representing the pattern of movement to a server which determines the authorization data based upon the pattern of movement, and send authorization data to the transaction terminal 12. One such example embodiment is now described with reference to FIG. 3.

In this example embodiment, the transaction processing system 10″ includes an authorization server, which illustratively comprises a payment processor server 40″. The payment processor server 40″ includes a processor 41″ coupled to a transceiver 42″ and a memory 43″. The memory 43″ is configured to store at least one pattern of movement representing a gesture.

The processor 16″ of the mobile wireless communications device 14″ is configured to detect a pattern of movement via at least one of the following: accelerometer 17″, magnetometer 23″, gyroscope 24″, or any combination thereof, for example. The processor 16″ then sends the detected gesture data representing the pattern of movement to the payment processor server 40″ via the transceiver 18″.

The processor 41″ of the payment processor server 40″, after receiving the gesture data representing detected pattern of movement, compares the gesture data representing the detected pattern of movement to the stored gesture data representing a stored pattern of movement. The processor 41″ then generates and sends the authorization data to the mobile wireless communications device using the transceiver 42″.

The stored pattern of movement may be stored in the memory 22″ during an association setting mode. In this mode, a gesture is performed, and data representative of the gesture is then sent from the mobile wireless communications device 14″ to the payment processor server 40″. Data representative of the gesture is saved in the memory 22″ of the payment processor server 40″, and then associated with a given payment account via the input device 19″ of the mobile wireless communications device 14″.

The processor 16″ of the mobile wireless communications device 14″ receives the authorization data from the payment processor server 40″, and in turn sends the authorization data to the transaction terminal 12″ via communication between the first NFC device 32″ and second NFC device 20″. The transaction terminal 12″ then effectuates the transfer of funds from the payment account to the merchant account.

In some applications, this transaction processing system 10″ may provide for additional security, as the proper pattern or patterns of movement are not stored in the memory 22″ of the mobile wireless communications device 14″, but rather in the memory 43″ of the payment processor server 40″.

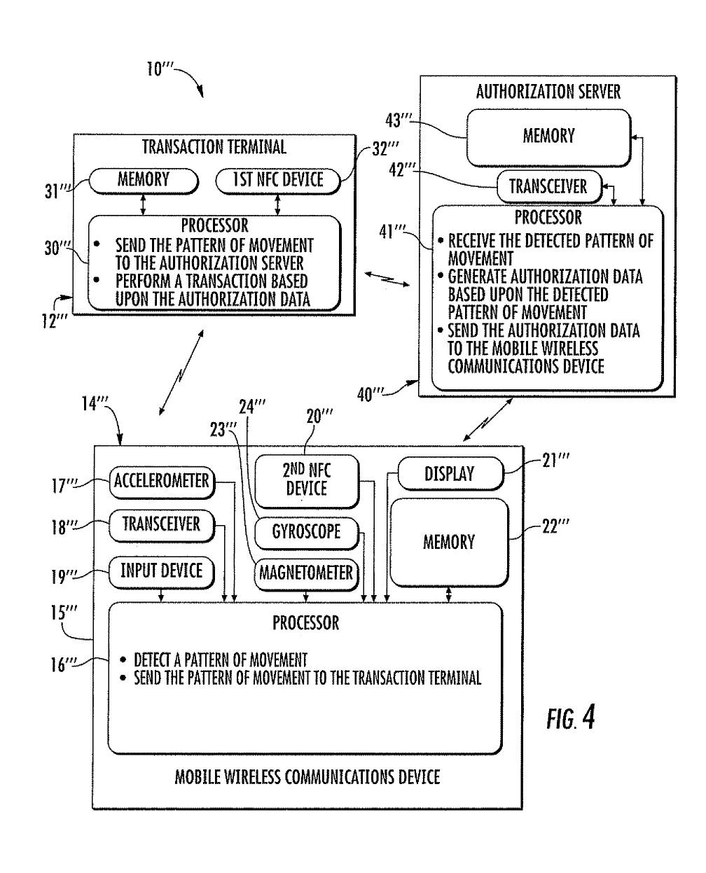

In some embodiments, the processor 16″ may be configured to detect the pattern of movement, and send the data representing the pattern of movement to an authorization server 40″, which determines the authorization data based upon the pattern of movement, either directly or indirectly. One such example embodiment is now described with reference to FIG. 4.

In this example embodiment, the transaction processing system 10″′ includes a transaction terminal 12″¹, authorization server 40″′, and mobile wireless communications device 14″′. Here, the processor 16″′ is configured to detect a pattern of movement (as described in detail above), and to then send data representing the pattern of movement to the transaction terminal 12″′ via communication between the first NEC device 32″′ and second NFC device 20″′.

The transaction terminal 12″′ receives the data representing the pattern of movement, and in turn sends it to the authorization server 40″′. The processor 41″′ of the authorization server 40″′ receives the data representing the pattern of movement, generates authorization data based thereupon, and sends the authorization data back to the transaction terminal 12″′. The transaction terminal 12″′ then performs a transaction based upon the authorization data.

In some applications, the processor 41″′ may send the authorization data to the mobile wireless communications device 14″′ instead of the transaction terminal 12″′, and that the mobile wireless communications device 14″′ may then in turn send the authorization data to the transaction terminal 12″′ via communication between the first NFC device 32″′ and second NFC device 20″′.

The transaction performed by the transaction terminal 12″′ need not be a payment transaction involving a transfer of funds, and may include other types of transactions. The transaction terminal 12″′ may be associated with a physical security device, such as lock on a door or a security barrier (e.g. gate, turnstile, etc.), and the transaction may be to operate the security device, for example. Furthermore, it should also be understood that the embodiments of the transaction processing systems 10, 10′, 10″, 10″′ described are example arrangements of features, and that other embodiments may include different arrangements.

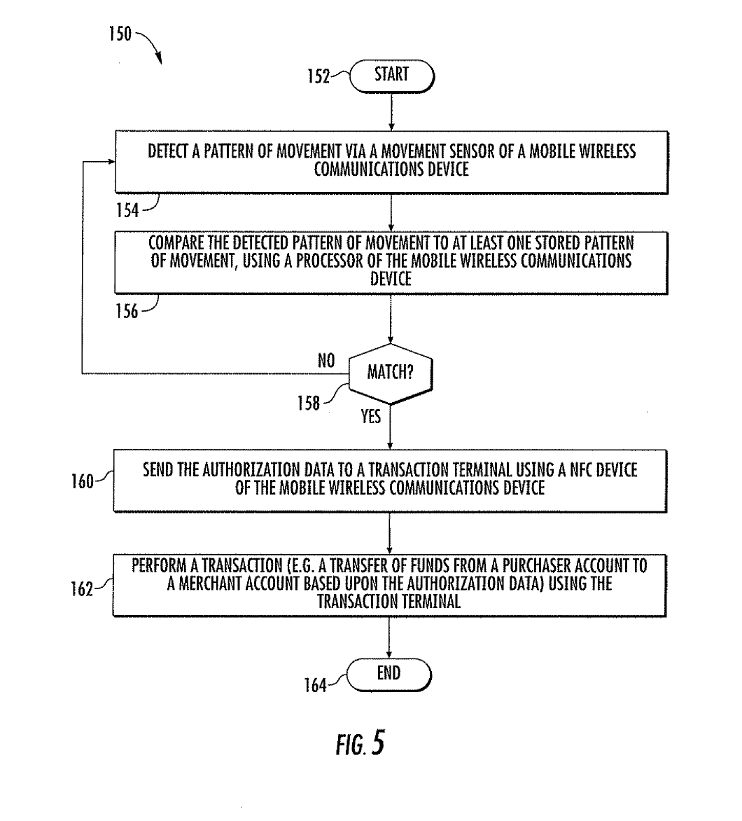

Referring now to the flowchart 150 shown in FIG. 5, related method aspects are now described. After the start (Block 152), a pattern of movement is detected via a movement sensor 17 of a mobile wireless communications device 14 (Block 154). Then, the detected pattern of movement is compared to at least one stored pattern of movement, using a processor 16 of the mobile wireless communications device 14 (Block 156).

At Block 158, if the detected pattern of movement is not determined to match or correspond to at least one of the stored patterns of movement, the mobile wireless communications 14 may continue to detecting a pattern of movement via the movement sensor 17, at Block 154, or discontinue movement detection after a certain period of time, etc. If the detected pattern of movement does match or correspond with at least one of the stored patterns of movement, the authorization data is sent to a transaction terminal 12 using a NFC device 20 of the mobile wireless communications device (Block 160). Then, the transaction terminal 12 effectuates a transfer of funds from a purchaser account to a merchant account based upon the authorization data (Block 162). Block 164 indicates the end of the method.

In some example embodiments, different gestures may be mapped to different types of authorizations. For example, at a gas pumping station, a first gesture may authorize a purchase of $10 of gas, a second gesture may authorize a purchase of $20, and a third gesture may authorize a sufficiently high purchase limit for a fill-up. In yet another similar example embodiment, different gestures may be mapped to different payment accounts. For example, a first gesture may authorize payment using a MasterCard, and a second gesture authorizes payment using a VISA card.

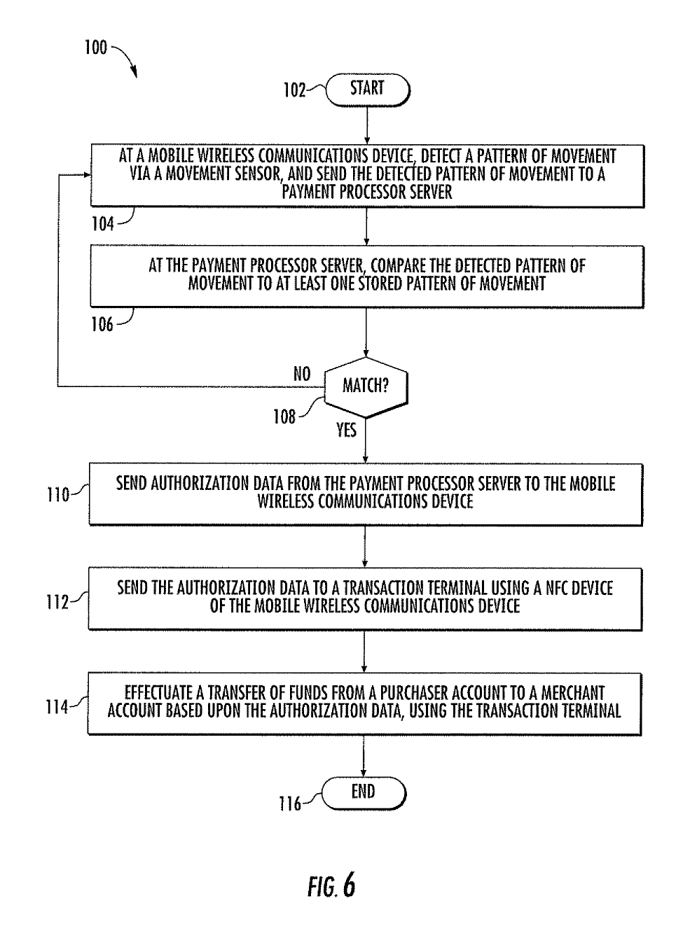

With reference to the flowchart 100 of FIG. 6, additional method aspects are now described. After the start (Block 102), a pattern of movement is detected via a movement sensor 17″ of a mobile wireless communications device 14″, and the data representing the detected pattern of movement is sent to a payment processor server 40″ (Block 104). Next, at the payment processor server 40″, the detected pattern of movement is compared to at least one stored pattern of movement (Block 106). At Block 108, if the detected pattern of movement is not determined to match or correspond with at least one of the stored patterns of movement, the mobile wireless communications device 14″ goes back to detecting a pattern of movement via the movement sensor 17″, at Block 154. If the detected pattern of movement is determined to match or correspond with at least one of the stored patterns of movement, authorization data is sent from the payment processor server 40″ to the mobile wireless communications device 14″ (Block 110). Then, the authorization data is sent to a transaction terminal 12″ using an NFC device 20″ of the mobile wireless communications device (Block 112). The transaction terminal 12″ may then effectuate a transfer of funds from a purchaser account to a merchant account based upon the authorization data (Block 114). Block 116 indicates the end of the method.

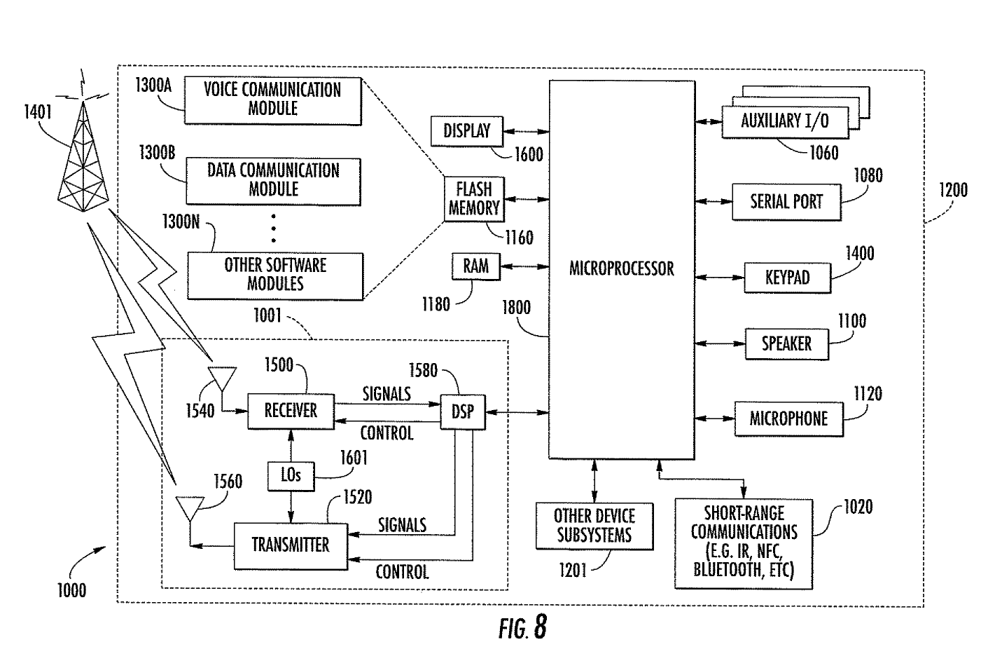

Example components of a mobile wireless communications device 1000 that may be used in accordance with the above-described embodiments are further described below with reference to FIG. 8. The device 1000 illustratively includes a housing 1200, a keyboard or keypad 1400 and an output device 1600. The output device shown is a display 1600, which may comprise a full graphic LCD. Other types of output devices may alternatively be utilized. A processing device 1800 is contained within the housing 1200 and is coupled between the keypad 1400 and the display 1600. The processing device 1800 controls the operation of the display 1600, as well as the overall operation of the mobile device 1000, in response to actuation of keys on the keypad 1400.

The housing 1200 may be elongated vertically, or may take on other sizes and shapes (including clamshell housing structures). The keypad may include a mode selection key, or other hardware or software for switching between text entry and telephony entry.

In addition to the processing device 1800, other parts of the mobile device 1000 are shown schematically in FIG. 8. These include a communications subsystem 1001; a short-range communications subsystem 1020; the keypad 1400 and the display 1600, along with other input/output devices 1060, 1080, 1100 and 1120; as well as memory devices 1160, 1180 and various other device subsystems 1201. The mobile device 1000 may comprise a two-way RF communications device having data and, optionally, voice communications capabilities. In addition, the mobile device 1000 may have the capability to communicate with other computer systems via the Internet.

Operating system software executed by the processing device 1800 is stored in a persistent store, such as the flash memory 1160, but may be stored in other types of memory devices, such as a read only memory (ROM) or similar storage element. In addition, system software, specific device applications, or parts thereof, may be temporarily loaded into a volatile store, such as the random access memory (RAM) 1180. Communications signals received by the mobile device may also be stored in the RAM 1180.

The processing device 1800, in addition to its operating system functions, enables execution of software applications 1300A-1300N on the device 1000. A predetermined set of applications that control basic device operations, such as data and voice communications 1300A and 1300B, may be installed on the device 1000 during manufacture. In addition, a personal information manager (PIM) application may be installed during manufacture. The PIM may be capable of organizing and managing data items, such as e-mail, calendar events, voice mails, appointments, and task items. The PIM application may also be capable of sending and receiving data items via a wireless network 1401. The PIM data items may be seamlessly integrated, synchronized and updated via the wireless network 1401 with corresponding data items stored or associated with a host computer system.

Communication functions, including data and voice communications, are performed through the communications subsystem 1001, and possibly through the short-range communications subsystem. The communications subsystem 1001 includes a receiver 1500, a transmitter 1520, and one or more antennas 1540 and 1560. In addition, the communications subsystem 1001 also includes a processing module, such as a digital signal processor (DSP) 1580, and local oscillators (LOs) 1601. The specific design and implementation of the communications subsystem 1001 is dependent upon the communications network in which the mobile device 1000 is intended to operate. For example, a mobile device 1000 may include a communications subsystem 1001 designed to operate with the Mobitex™, Data TAC™ or General Packet Radio Service (GPRS) mobile data communications networks, and also designed to operate with any of a variety of voice communications networks, such as AMPS, TDMA, CDMA, WCDMA, PCS, GSM, EDGE, etc. Other types of data and voice networks, both separate and integrated, may also be utilized with the mobile device 1000. The mobile device 1000 may also be compliant with other communications standards such as 3GSM, 3GPP, UMTS, 4G, etc.

Network access requirements vary depending upon the type of communication system. For example, in the Mobitex and DataTAC networks, mobile devices are registered on the network using a unique personal identification number or PIN associated with each device. In GPRS networks, however, network access is associated with a subscriber or user of a device. A GPRS device therefore typically involves use of a subscriber identity module, commonly referred to as a SIM card, in order to operate on a GPRS network.

When required network registration or activation procedures have been completed, the mobile device 1000 may send and receive communications signals over the communication network 1401. Signals received from the communications network 1401 by the antenna 1540 are routed to the receiver 1500, which provides for signal amplification, frequency down conversion, filtering, channel selection, etc., and may also provide analog to digital conversion. Analog-to-digital conversion of the received signal allows the DSP 1580 to perform more complex communications functions, such as demodulation and decoding. In a similar manner, signals to be transmitted to the network 1401 are processed (e.g. modulated and encoded) by the DSP 1580 and are then provided to the transmitter 1520 for digital to analog conversion, frequency up conversion, filtering, amplification and transmission to the communication network 1401 (or networks) via the antenna 1560.

In addition to processing communications signals, the DSP 1580 provides for control of the receiver 1500 and the transmitter 1520. For example, gains applied to communications signals in the receiver 1500 and transmitter 1520 may be adaptively controlled through automatic gain control algorithms implemented in the DSP 1580.

In a data communications mode, a received signal, such as a text message or web page download, is processed by the communications subsystem 1001 and is input to the processing device 1800. The received signal is then further processed by the processing device 1800 for an output to the display 1600, or alternatively to some other auxiliary I/O device 1060. A device may also be used to compose data items, such as e-mail messages, using the keypad 1400 and/or some other auxiliary I/O device 1060, such as a touchpad, a rocker switch, a thumb-wheel, or some other type of input device. The composed data items may then be transmitted over the communications network 1401 via the communications subsystem 1001.

In a voice communications mode, overall operation of the device is substantially similar to the data communications mode, except that received signals are output to a speaker 1100, and signals for transmission are generated by a microphone 1120. Alternative voice or audio I/O subsystems, such as a voice message recording subsystem, may also be implemented on the device 1000. In addition, the display 1600 may also be utilized in voice communications mode, for example to display the identity of a calling party, the duration of a voice call, or other voice call related information.

The short-range communications subsystem enables communication between the mobile device 1000 and other proximate systems or devices, which need not necessarily be similar devices. For example, the short-range communications subsystem may include an infrared device and associated circuits and components, a Bluetooth™ communications module to provide for communication with similarly-enabled systems and devices, or a near field communication (NFC) sensor for communicating with a NFC device or NFC tag via NFC communications.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A transaction processing system comprising:
an authorization server;
a transaction terminal including a first near field communication (NFC) device; and
a mobile wireless communications device comprising a second NFC device, at least one movement sensor, and a processor configured to
send a transaction request via said second NFC device to said first NFC device of said transaction terminal, and
send detected data representing a pattern of movement detected by said at least one movement sensor to the authorization server;
said authorization server configured to generate authorization data based upon the detected data;
said transaction terminal configured to perform a transaction based upon the transaction request and the authorization data.

2. The transaction processing system of claim 1 wherein said authorization server is further configured to send the authorization data to said mobile wireless communications device; and wherein said processor is further configured to send the authorization data to the transaction terminal via communication between said first NFC device and said second NFC device.

3. The transaction processing system of claim 1 wherein said mobile wireless communications device further comprises a wireless transceiver; and wherein said processor is configured to send the detected data to said authorization server via said wireless transceiver.

4. The transaction processing system of claim 1 wherein said processor is configured to send the detected data to said authorization server via said transaction terminal.

5. The transaction processing system of claim 1 wherein said mobile wireless communications device further comprises an input device; and wherein said processor is configured to generate the data representing the pattern of movement based upon the pattern of movement detected by said at least one movement sensor and said input device.

6. The transaction processing system of claim 1 wherein said authorization server further comprises a memory configured to store data corresponding to at least one pattern of movement; and wherein said authorization server is configured to generate the authorization data by comparing the detected data to the stored data.

7. The transaction processing system of claim wherein the stored data corresponds to a plurality of different patterns of movement each associated with a respective different payment account.

8. The transaction processing system of claim 1 wherein the transaction comprises causing a transfer of funds from a payment account associated with the authorization data to a merchant account.

9. The transaction processing system of claim 1 wherein the transaction comprises a security transaction.

10. The transaction processing system of claim 1 wherein said at least one movement sensor comprises at least one of an accelerometer, a magnetometer, or a gyroscope.

11. A transaction processing system comprising:
an authorization server;
a transaction terminal including a first near field communication (NFC) device;
a mobile wireless communications device comprising a second NFC device, at least one movement sensor, and a processor configured to send a detected data representing a pattern of movement detected by said at least one movement sensor to said authorization server;
said authorization server configured to generate authorization data based upon the detected data and to send the authorization data to said mobile wireless communications device;
said processor configured to send the authorization data to said transaction terminal via communication between said first NFC device and said second NFC device;
said transaction terminal configured to cause a transfer of funds from a payment account associated with the authorization data to a merchant account based upon the authorization data.

12. The transaction processing system of claim 11 wherein said mobile wireless communications device further comprises a wireless transceiver; and wherein said processor is configured to send the detected data to said authorization server via said wireless transceiver.

13. The transaction processing system of claim 11 wherein said processor is configured to send the detected data to said authorization server via said transaction terminal.

14. The transaction processing system of claim 11 wherein said mobile wireless communications device further comprises an input device; and wherein said processor is configured to generate the data based upon the pattern of movement detected by said at least one movement sensor and said input device.

15. The transaction processing system of claim 11 wherein said authorization server further comprises a memory configured to store data corresponding to at least one pattern of movement; and wherein said authorization server is configured to generate the authorization data by comparing the detected data to the stored data.

16. The transaction processing system of claim 15 wherein the stored data corresponds to a plurality of different patterns of movement each associated with a respective different payment account.

17. A method of operating a transaction processing system comprising an authorization server, a transaction terminal comprising a first near field communication (NFC) device, and a mobile wireless communications device comprising at least one movement sensor and a second NFC device, the method comprising:
sending detected data representing a pattern of movement detected by the at least one movement sensor from the mobile wireless communications device to the authorization server;
generating authorization data based upon the detected data at the authorization server;
sending a transaction request from the second NFC device of the mobile wireless communications device to the first NFC device of the transaction terminal; and
performing a transaction based upon the transaction request and the authorization data using the transaction terminal.

18. The method of claim 17 further comprising:
sending the authorization data to the mobile wireless communications device from the authorization server; and
sending the authorization data from the mobile wireless communications device to the transaction terminal via communication between the first NFC device and the second NFC device.

19. The method of claim 17 wherein the mobile wireless communications device further comprises a wireless transceiver; and the method further comprising sending the detected data from the mobile wireless communications device to the authorization server via the wireless transceiver.

20. The method of claim 17 wherein sending the detected data comprises sending the detected data from the mobile wireless communications device to the authorization server via the transaction terminal.

21. The method of claim 17 wherein said mobile wireless communications device further comprises an input device; and the method further comprising generating the data based upon the pattern of movement detected by the at least one movement sensor and the input device.

22. The method of claim 17 wherein the authorization sever further comprises a memory configured to store data corresponding to at least one pattern of movement; and wherein generating the authorization data further comprises generating the authorization data by comparing the detected data to the stored data.

23. The method of claim 22 wherein the stored data corresponds to a plurality of different patterns of movement each associated with a respective different payment account.

24. The method of claim 17 wherein the transaction comprises causing a transfer of funds from a payment account associated with the authorization data to a merchant account.

25. The method of claim 17 wherein the transaction comprises a security transaction.
